(19) United States
(12) Patent Application Publication
(10) Pub. No.: US 2003/0175413 A1
(43) Pub. Date: Sep. 18, 2003

(54) Surface coating on a liquid/solid contact surface for controlling electrical osmosis

(76) Inventors: Johan-Valentin Kahl, Neustatterstr.1 (DE); Roman Zantl, Flugweg (DE)

Correspondence Address: IP Strategies, 1730 N. Lynn Street, Suite 500, Arlington, VA, 22209, US

(21) Appl. No.: 10/312,789

(22) PCT Filed: Jul. 4, 2001
(86) PCT No.: PCT/DE01/02512

(30) Foreign Application Priority Data
Jul. 4, 2000 (DE) 10032329.4

(51) Int. Cl. B05D 5/12

(52) U.S. Cl. 427/58

(57) ABSTRACT

The invention relates to a surface coating oh an interface between a liquid and a solid, which allows the neutralization of charged surfaces in an aqueous solution or the generation of exactly defined surface charges. For this purpose the surface is coated with neutral and/or charged macromolecules, amphiphilic molecules or polymers being suited, individually or combined, to adjust a predetermined surface charge on the interface or to neutralize a given surface charge. If the coating contains neutral macromolecules, undesired effects caused by the electric osmosis are prevented. If the macromolecules are charged, an exactly defined surface charge can be adjusted.

The invention relates to a surface coating, especially to a surface coating on an interface between a liquid and a solid.

Different scientific, especially electrokinetic experiments and processes are, for instance, based on the effect of electric osmosis, whereby, when an electric field is applied to an aqueous solution, the ionic movement caused thereby is utilized. Thus, for example, macromolecules such as DNA, proteins, enzymes, bacteria, viruses etc. can be shifted or placed on an object slide. Moreover, it is feasible to determine the surface potential, the so-called zeta potential, of different surfaces,

The surfaces of all known materials have, however, an intrinsic surface charge and, thus, a surface potential on an interface to an aqueous solution. For neutralizing this surface potential oppositely charged ions (counter-ions) attach to the charged surface, i.e. an electric double layer is formed on the interface between the liquid and the solid. This double layer also exists if the aqueous solution does not contain ions. It then results from the orientation of the dipolar water molecules and the formation of OH⁻ and H₃O⁺ molecules.

If, like in the aforementioned electrokinetic experiments and processes, an electric field is applied parallel to the interface between the liquid and the solid, the electric osmosis causes a migration of this “oppositely charged layer” in the liquid relative to the surface of the solid.

In measurements of, for instance, the zeta potential or the movement of molecular formations a great inaccuracy in the parameters to be measured or adjusted is thereby caused. These negative consequences are shown particularly in the use of small closed channels (diameter 1 cm-1 μm). If charged molecules or dipolar molecules in liquid are filled into such a channel, and if said molecules are to be shifted by applying an electric field, the molecules move, in response to the distance to the wall, differently fast or even in different directions. The cause therefor is due to the fact that there is a counter-flow to the ions moving along the charged walls in the closed channels and, thus, to the entrained liquid or the molecular dipoles. Thus, the inaccuracy of the distribution of the molecules, which is otherwise only caused by the diffusion of the molecules, is strongly increased.

In open channels or systems the electric osmosis results in a formation of hydrodynamic pressures. The switching off of the electric field results in vibrations or random motions in the system. All this entails that smallest amounts of spatially clearly defined molecular distributions (in response to the channel size, amounts of 1 μl to 1 nl) cannot be moved by means of electric fields, with the simultaneous maintenance of the spatial distribution, in a defined manner.

This effect is especially dramatic in salt concentrations of less than 10 mM, as the intensity of the electric osmosis is inversely proportional to the salt concentration. Hence, it is impossible to create miniaturized channel systems, in which different types of molecules can exactly be placed at certain locations by means of electric fields.

Furthermore, it is possible only with extreme difficulties to determine the zeta potential of a microscopically large particle by applying an electric field to an aqueous solution, as the velocity of the particle, which has to be used for the measurement, depends on the distance of the particle to the solid surface as well as on the charge of the surface and the geometry thereof (e.g. shape of the channel).

In closed channels the measurements, therefore, have to be performed in the so-called stationary level of the channel. Due to the different flow directions caused by the electric osmosis there is a level between the wall and the center of the channel, in which no flow takes place: the stationary level. The limitation to said level, however, causes an additional uncertainty factor in corresponding processes.

Moreover, when a hydrodynamic flow is applied, a so-called streaming potential along the flow direction is formed on charged surfaces, such as the interfaces between a liquid and a solid. In experiments this potential results in an interference with the spatial arrangement of the molecules to be examined, or, respectively, with the electric field to be determined, thereby falsifying the measurements in addition to the electric osmotic effects.

It is the object of the present invention to provide a surface coating, which allows the neutralization of a surface potential on an interface between a liquid and a solid, or the adjustment thereof to a predetermined value, such that undesired effects by the electric osmosis and a streaming potential are avoided.

According to the invention this object is provided by the features described in claim 1. Advantageous embodiments of the invention are described in the subclaims.

Accordingly, the surface coating on an interface between a liquid and a solid is formed by charged and/or neutral macromolecules, amphiphilic molecules, lipids and/or polymers, which are, individually or combined, suited to adjust a predetermined surface charge on the interface or, respectively, to neutralize a given surface charge.

By coating charged surfaces with neutral or charged amphiphilic macromolecules, the surface potential is neutralized inside the liquid or, respectively, is adjusted to a predetermined value. Undesired effects due to the electric osmosis can, thus, be avoided.

For surface coatings according to the present invention, not only polymers but all natural and artificial lipids may be used as charged or neutral macromolecules, e.g. phospholipids such as sphingolipids, plasmalogens, phosphatides and lysophospholipids, especially phosphocholine, phosphatidyl ethanolamine, phosphatidyl serine, phosphatidyl inositol and phsophatidyl glycerol (DOPC, SOPC, POPC, DOTAP, DMPC, DMTAP, etc.), moreover glycol ipides such as cerebrosides, sulfatides and gangliosides, waxes, neutral fats and cardiolipin.

According to a preferred embodiment phospholipids are employed for the coating, which will be described in the following as well as in the embodiment examples.

Phospholipids have the following general structure:

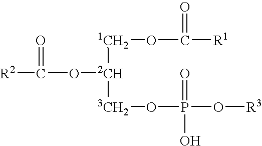

wherein R¹ and R² can be equal or different and can be a saturated or unsaturated fatty acid with 10 to 30 C-atoms.

If the phospholipids are neutral, R³ is, for example, an amino alcohol with 3 to 10 C-atoms. The neutral lipids used in the embodiment examples were those with phoshatidyl choline (PC) as head group and different chains, such as dioleoyl (DO), steraoyl-oleoyl (SO), palmitoyl-oleoyl (PO), dimirystoyl (DM) etc.

If the phospholipids are cationic, R³ carries an altogether positive charge and is, for example, a trialkyl residue with 1 to 5 C-atoms per alkyl group. The cationic lipids used in the embodiment examples were those with a head group from dimethyl-ammonium propane (DAP), trimethylammonium propane (TAP) etc. and a chain from dioleoyl (DO), dimirystoyl (DM) etc.

If the phopholipids are anionic, R³ carries an altogether negative charge and is, for example, an amino or hydroxyalkyl residue with 1 to 10 C-atoms and 1 to 4 amino and/or hydroxy groups. The anionic lipids used in the embodiment examples were those with a head group from phosphatidyl glycerol (PG), phosphatidyl serine (PS) etc. and a chain, for example, from dimirystoyl (DM).

Apart from the neutralization by the complete coating of a surface, the coating of selected regions on a charged surface allows the prevention of the negative effect of the electric osmosis in these regions only. Thus, with the aid of electric fields, spatially arranged molecular formations can be moved over a surface or through a channel, whereby the change of the spatial structure of the molecular formation is only determined by the diffusion and the friction in the channel.

The coating may be performed with different methods, which are described in the following embodiment examples. It may particularly be used in miniaturized channel systems (diameter 1 nm-10 mm) with, for instance, a round or rectangular cross-section, so as to allow the movement of molecules in the same, e.g. by electric fields. Said channel systems may, for example, be placed in silicon dioxide, quartz, glass or a plastic material. Any other materials capable for being structured are, however, likewise conceivable.

By coating a channel surface with neutral lipids it also becomes possible to measure the zeta potential of small charged objects (100 nm-100 μm) at any optional location of the channel, independently of the stationary level.

Moreover, it is possible to generate an exactly defined surface charge by charged macromolecules. Especially different regions inside a channel system can be coated with different macromolecules, so that an electric osmosis with a different intensity can be generated.

Furthermore, the membrane applied on the surface may be fluid.

By neutralizing the surface by means of the methods as described above the streaming potential is, moreover, strongly reduced or, respectively, entirely eliminated, so that no undesired and interfering electric fields along a measurement channel occur.

A surface coating according to the present invention can be employed for any kind of object slide or sample chamber onto which aqueous liquids can be applied.

### EMBODIMENT EXAMPLES

1. Isopropanol is filled into a channel made of polycarbonate and having a height of 100 μm, a width of 1 mm and a length of 5 cm, said isopropanol containing 100 μg DOPC/ml. The channel is thereupon slowly (3 min.) rinsed with water containing 10 mM HEPES buffer with a pH of 7.0. A closed lipid layer is now located on the wall of the channel. If neutral DOPC vesicles are subsequently filled into the channel, they same do not move when an electric field (100 V/5 cm) is applied simultaneously. In other words, there is no electric osmosis.

2. Water is filled into a channel made of glass and having a height of 100 μm, a width of 1 mm and a length of 5 cm, said water containing 100 μg/ml SOPC vesicles, 60 mM NaCl and 10 mM tris. Said solution remains in the channel between 2 min. to 3 h. Afterwards, thorough rinsing with water containing 10 mM HEPES with a pH of 7 takes place. In this case, too, a charge neutrality of the wall appears. If glass spheres having a defined surface charge and a diameter of 1 μm are filled into the channel, the zeta potential of the glass spheres, which depends on the salt concentration, can be measured in the entire channel independently of the distance between the glass sphere and the wall of the channel. In other words, no limitation to the stationary level is necessary. Thus, the zeta potential of a clean sphere in 1 mM NaCl 10 mM HEPES pH 7.0 is about 50 (±5) mV.

3. Isopropanol containing 100 μg DOPC/ml is filled onto a glass carrier having a size of 3×3 cm. The surface is thereupon rinsed with water containing 10 mM HEPES pH 7.0 until no isopropanol is left in the solution. If neutral DOPC vesicles are subsequently added to the solution above the surface, the same do not move when an electric field (100 V/5 cm) is applied. In other words, there is no electric osmosis.

1. Surface coating on an interface between a liquid and a solid, characterized in that it contains charged and/or neutral macromolecules, amphiphilic molecules, lipids and/or polymers being suited, individually or combined, to adjust a predetermined surface charge on the interface or to neutralize a given surface charge.

2. Surface coating according to claim 1, characterized in that the coating is suited to prevent or control electric osmosis in an aqueous solution above the coating.

3. Surface coating according to claim 1 or 2, characterized in that the charged and/or neutral macromolecules are phospholipids.

4. Surface coating according to claim 1 or 2, characterized in that the neutral macromolecules are selected from a group having the following general formula I: 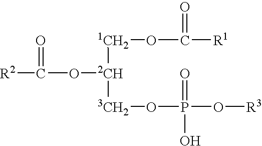
wherein R¹ and R² are equal or different and are a saturated or unsaturated fatty acid with 10 to 30 C-atoms, and R3 preferably is an amino alcohol with 3 to 10 C-atoms.

5. Surface coating according to claim 1 or 2, characterized in that the cationic macromolecules are selected from a group having the general formula I according to claim 3, wherein R¹ and R² have the meaning indicated in claim 3 and R³ has an altogether positive charge and preferably is a trialkyl residue with 1 to 5C-atoms per alkyl group.

6. Surface coating according to claim 1 or 2, characterized in that the anionic macromolecules are selected from a group having the general formula I according to claim 3, wherein R¹ and R ²have the meaning indicated in claim 3, and R³ has an altogether negative charge and preferably is an amino or hydroxyalkyl residue with 1 to 10 C-atoms and 1 to 4 amino and/or hydroxy groups.

7. Surface coating according to one of the preceding claims, characterized in that the coating is suited to prevent or control a streaming potential in an aqueous solution above the coating.

8. Surface coating according to one of the preceding claims, characterized in that it is applied on the surfaces of a miniaturized channel system.

9. Surface coating according to one of the preceding claims, characterized in that the solid is formed of glass, silicon dioxide or plastics.

10. Use of a surface coating according to one of the preceding claims for the coating of analysis surfaces of electrokinetic devices.

11. Use according to claim 10 in electric osmosis apparatus as electrokinetic device.
